(19) United States
(12) Patent Application Publication
(10) Pub. No.: US 2005/0013637 A1
(43) Pub. Date: Jan. 20, 2005

(54) Method and apparatus for preventing contamination of transfer roller in image forming system

(76) Inventors: Cheol-Ju Yang, Metropolitan-City (KR); Jun-Bae Jeon, Seoul (KR)

Correspondence Address: Christian C. Michel;Roylance, Abrams, Berdo & Goodman, L.L.P., Suite 600, 1300 19th Street, N.W., Washington, DC, 20036, US

(21) Appl. No.: 10/673,562

(22) Filed: Sep. 30, 2003

(30) Foreign Application Priority Data
Jul. 14, 2003 (KR) 2003-47718

(51) Int. Cl. G03G 15/16

(52) U.S. Cl. 399/313

(57) ABSTRACT

Provided is a method and apparatus for preventing contamination of a transfer roller in an image forming system. The method comprises (a) setting a separation time of the transfer roller from a transfer belt according to the size of paper picked-up from a paper feeding cassette and the size of paper set in a printer driver, and (b) separating the transfer roller from the transfer belt when the separation time of the transfer roller set in (a) has elapsed.

### BACKGROUND OF THE INVENTION

This application claims priority from Korean Patent Application No. 2003-47718, filed on Jul. 14, 2003, in the Korean Intellectual Property Office, the disclosure of which is incorporated herein by reference in its entirety.

1. Field of the Invention

The present invention relates to an image forming system, and more particularly, to a method and apparatus for preventing a transfer roller from being contaminated by toner in an image forming system when the size of paper set in a printer driver is different from the size of paper supplied from a paper feeding cassette.

2. Description of the Related Art

In an electrophotographic image forming system, when an exposure unit radiates light onto a photosensitive medium charged to a predetermined potential, an electrostatic latent image is formed on the photosensitive medium. Thereafter, a developing unit forms a toner image by supplying toner to the electrostatic latent image. In general, a color electrophotographic image forming system needs four developing units in which four color toners, such as cyan (C), magenta (M), yellow (Y), and black (B), are respectively stored. The toner image is transferred onto paper directly from the photosensitive medium or via an intermediate transfer medium. When the transferred toner image passes a fusing unit, the toner image is fused on the paper by heat and pressure. A single color or multiple color image is printed on the paper through the above procedure.

As a basic rule for the above image forming system, paper having a size appropriate for the size of an image to be formed on the photosensitive medium is supplied according to printing conditions set in a printer driver. However, in some cases, paper of an appropriate size for the size of the image cannot be supplied. When the size of the image is smaller than the size of the paper, printing problems do not occur. However, when the size of the image is larger than the size of the paper, toner corresponding to portions from the toner image formed on the photosensitive medium is transferred to a transfer roller. As a result, next sheet of paper is contaminated, or a transfer bias potential of the transfer roller is substantially reduced, causing transfer defects.

In order to solve these problems, in conventional printers, the transfer roller is cleaned by changing a polarity used during an image transfer operation and transferring toner attached onto the transfer roller on the photosensitive medium before and after a printing operation is performed on new paper. However, this added step increases the amount of time required for driving the system. As such, the life span of the system may be reduced, and an entire time required for a printing operation may increase. Additionally, when the size of paper set in the printer driver is different from the size of paper supplied from a paper feeding cassette, jamming occurs and the printing operation is stopped. As such, additional efforts and time are needed to return to a printable state.

### SUMMARY OF THE INVENTION

The present invention provides a method and apparatus for preventing a transfer roller from being contaminated by toner in an image forming system when the size of paper set in a printer driver is different from the size of paper supplied from a paper feeding cassette, and an image forming system using the method and apparatus.

According to an aspect of the present invention, a method for preventing contamination of a transfer roller in an image forming system includes (a) setting a separation time of the transfer roller from a transfer belt according to the actual size of paper picked-up from a paper feeding cassette and the size of paper set in a printer driver, and (b) separating the transfer roller from the transfer belt when the separation time of the transfer roller set in (a) has elapsed.

According to another aspect of the present invention, an apparatus for preventing contamination of a transfer roller in an image forming system includes a transfer roller separation time setting unit, which sets a separation time of a transfer roller from a transfer belt to a first or second time period according to a comparison between the size of paper picked-up from a stacking unit and the size of the paper set in a printer driver. The apparatus further includes a transfer roller controller, which makes the transfer belt contact the transfer roller to perform a transfer operation from a time when a rear end of paper is detected by a paper feeding sensor to the set separation time of the transfer roller, and which separates the transfer roller from the transfer belt when the separation time of the transfer roller has elapsed.

According to another aspect of the present invention, an image forming system includes a controller. The controller sets a separation time of a transfer roller from a transfer belt to a first or second time period according to a comparison between the size of paper picked-up from a paper feeding cassette and the size of the paper set in a printer driver. The controller also controls the transfer belt such that the transfer belt contacts the transfer roller to perform a transfer operation from a time when a rear end of paper is detected by a paper feeding sensor to the set separation time of the transfer roller; and separates the transfer roller from the transfer belt when the separation time of the transfer roller has elapsed.

According to another aspect of the present invention, the method may be implemented using a computer readable medium on which a program for executing the method in a computer is recorded.

### BRIEF DESCRIPTION OF THE DRAWINGS

The above and other aspects and advantages of the present invention will become more apparent by describing in detail preferred embodiments thereof with reference to the attached drawing figures in which:

FIG. 1 is a side cross-sectional view illustrating the mechanism of an image forming system using a method for preventing a transfer roller from being contaminated, according to an embodiment of the present invention;

FIG. 2 is a functional block diagram illustrating a function of the image forming system for performing the method for preventing a transfer roller from being contaminated, according to an embodiment of the present invention;

FIG. 3 is a flowchart illustrating a method for preventing a transfer roller from being contaminated in an image forming system, according to an embodiment of the present invention; and

FIG. 4 is a block diagram illustrating a structure of an apparatus for preventing a transfer roller from being contaminated in an image forming system, according to an embodiment of the present invention.

In the drawing figures, it will be understood that like numerals refer to like features and structures.

### DETAILED DESCRIPTION OF THE INVENTION

Hereinafter, preferred embodiments of the present invention will be described in detail with reference to the accompanying drawing figures.

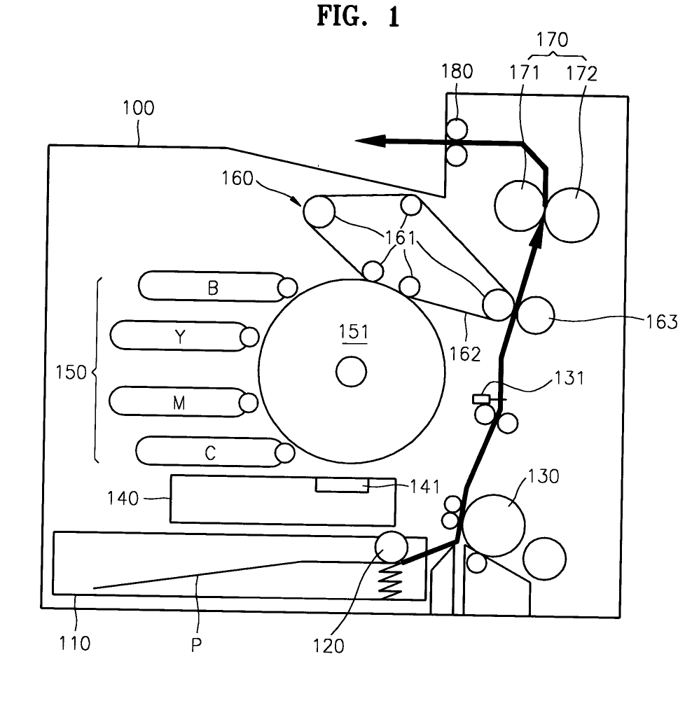

FIG. 1 is a side cross-sectional view illustrating the mechanism of an image forming system using a method for preventing a transfer roller from being contaminated, according to an embodiment of the present invention. The image forming system includes a stacking unit 110, a pickup unit 120, a paper feeding unit 130, an exposure unit 140, a developing unit 150, a transfer unit 160, a fusing unit 170, and a paper exhausting unit 180.

Referring to FIG. 1, the stacking unit 110, generally a cassette, is installed in a lower portion of a main body 100, to be attached to or detached from the main body 100, and paper P is stacked therein. The paper P is picked-up by the pickup unit 120, which is rotatably installed in the main body 100, and transferred inside the main body 100 generally in the direction of the arrow.

The pickup unit 120, generally a pickup roller, picks up the paper P from the stacking unit 110. The paper feeding unit 130, generally a paper feeding roller, transfers the paper P picked-up from the stacking unit 110 inside the main body 100. A paper feeding sensor 131 detects a front end of the paper P and senses whether pickup of the paper P from the stacking unit 110 is successfully performed by the pickup unit 120 according to a detection result of the front end of the paper P.

The exposure unit 140 radiates light corresponding to an image signal on a photosensitive drum 151 charged to have a uniform potential to form an electrostatic latent image. In general, the exposure unit 140 is a laser scanning unit (LSU) using a laser diode as a light source. In this case, a light window 141 is opposite to the photosensitive drum 151. A laser beam from the laser diode is radiated through light window 141 onto photosensitive drum 151.

The developing unit 150 comprises a plurality of ink cartridges adapted to contact the photosensitive drum 151 so as to develop the electrostatic latent image formed on the surface of the photosensitive drum 151 by the exposure unit 140, as a predetermined color image, in response to the image signal. A developing agent stored in the plurality of ink cartridges is used to form a predetermined visible image on the electrostatic latent image formed on the photosensitive drum 151.

The transfer unit 160 includes a transfer belt 162, which is supported by a plurality of transfer belt backup rollers 161 and rotated in a closed loop and on which the toner image formed on the surface of the photosensitive drum 151 is transferred.

The transfer unit 160 further includes a transfer roller 163, which is installed to be opposite to one of the plurality of transfer belt backup rollers 161. The transfer belt 162 is placed between the plurality of transfer belt backup rollers 161 and the transfer roller 163, and presses the paper P toward the transfer belt 162. Thus, a color toner image transferred from the photosensitive drum 151 to the transfer belt 162 is transferred onto the paper P. The traveling linear velocity of the transfer belt 162 is preferably the same as a rotation linear velocity of the photosensitive drum 151. In addition, the length of the transfer belt 162 is preferably the same as or longer than the length of the paper P in which the color toner image is finally received.

In the transfer unit 160, the transfer roller 163 is installed to be opposite to the transfer belt 162. The transfer roller 163 is separated from the transfer belt 162 by a solenoid (not shown) while the color toner image is transferred to the transfer belt 162. When the color toner image is completely transferred to the transfer belt 162, the transfer roller 163 contacts the transfer belt 162 at a predetermined pressure, so as to transfer the color toner image onto the paper P.

The fusing unit 170 includes a fusing roller 171 which generates heat, and a pressing roller 172 which is installed opposite the fusing roller 171. The paper P is placed between the fusing roller 171 and the pressing roller 172, and presses the paper P toward the fusing roller 171. The fusing roller 171 applies heat to the paper P in which the visible image is formed, and fuses the visible image onto the paper P.

The paper exhausting unit 180, generally a paper exhausting roller, exhausts the paper P in which the visible image is formed to outside. In order to perform printing on both sides, the paper exhausting unit 180 is reversed. As such, the paper P is reversely rotated and transferred to a reversal path.

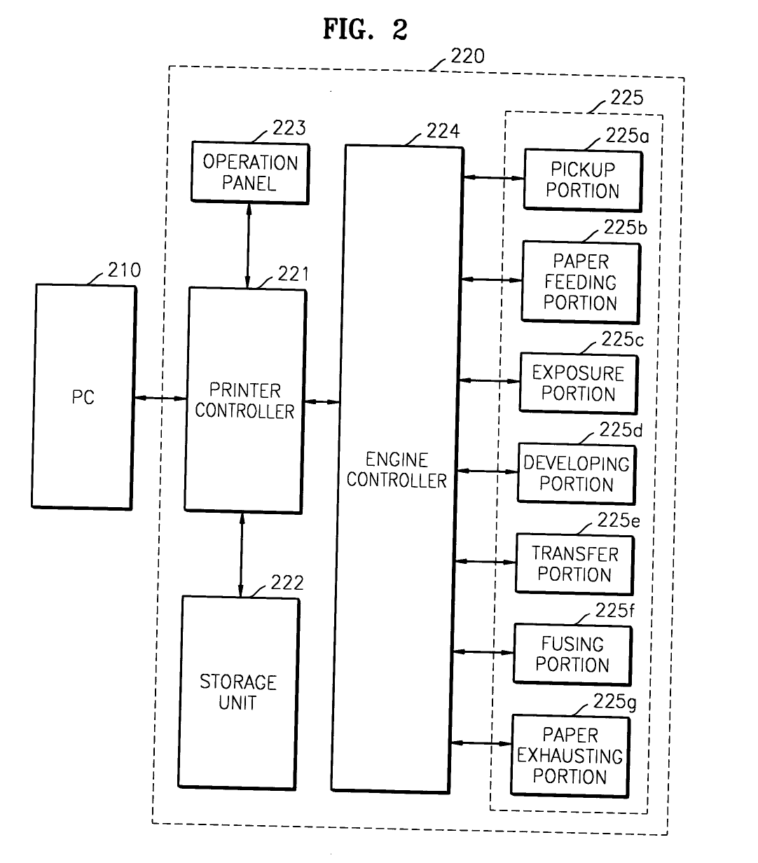

FIG. 2 is a functional block diagram illustrating a function of an image forming system 220 for performing the method for preventing a transfer roller from being contaminated. The image forming system 220 includes a printer controller 221, a storage unit 222, an operation panel 223, an engine controller 224, and an engine unit 225.

Referring to FIG. 2, the printer controller 221 converts a printing data received from outside, e.g., from a computer (PC) 210 connected to a communication interface, into an image data appropriate for driving the engine unit 225 according to printing conditions set in a printer driver (not shown) and stores the image data in the storage unit 222.

The storage unit 222 stores various control programs required to implement the function of the image forming system 220, various data generated in the printer controller 221 by performing the control programs, the printing data received from the PC 210, and printing information temporarily.

The operation panel 223 includes a key matrix and a display. The key matrix generates data according to keys pressed by a user to designate each mode and to perform an operation in a designated mode, and outputs the data to the printer controller 221. The display displays the operational state of the system when the printer controller 221 executes each mode.

The engine controller 224 controls the engine unit 225 so that an image corresponding to the image data received from the printer controller 221 is printed on the paper P. For this purpose, when a printing instruction command is received from the printer controller 221, the engine controller 224 controls the engine unit 225 so that each of portions 225a-225g of the engine unit 225 is prepared to perform a printing operation. An example of printing operation preparation is to rotate a polygonal rotating mirror or a scan disc, which is a deflection means of an exposure portion 225c, at a predetermined speed required during the printing operation, or to heat a fusing portion 225f to a predetermined temperature, or to check whether something is wrong with each device that performs the printing operation.

Thus, after the printing instruction command is received from the printer controller 221, when it is determined that the printing operation can be performed after a printing preparation time, the engine controller 224 controls the engine unit 225 to apply a printing starting signal to the printer controller 221 and to supply an image data stored in the storage unit 222 to the exposure portion 225c via the engine controller 224.

The engine unit 225 includes various portions required for the printing operation. For example, in the case of electrophotographic image forming system, the engine unit 225 includes a pickup portion 225a, a paper feeding portion 225b, an exposure portion 225c, a developing portion 225e, a fusing portion 225f, and a paper exhausting portion 225g, as shown in FIG. 2. In this way, the engine unit 225 may be formed in various shapes according to a printing method.

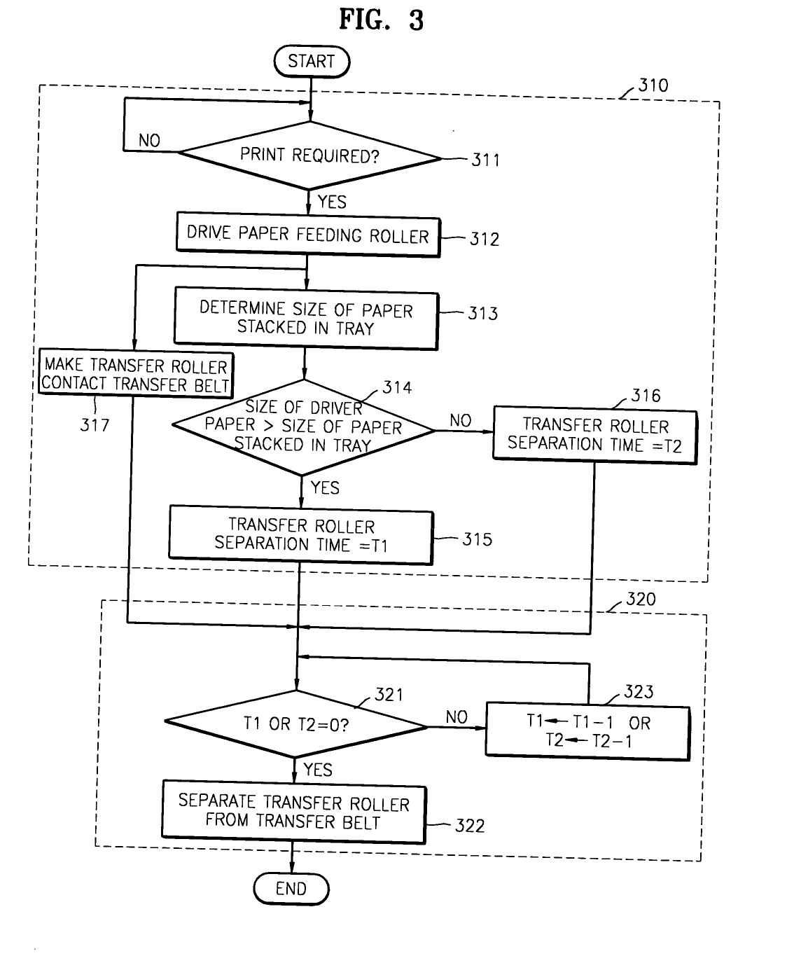

FIG. 3 is a flowchart illustrating a method for preventing a transfer roller from being contaminated, according to an embodiment of the present invention. The method for preventing a transfer roller from being contaminated comprises steps 310 and 320, and will be described with reference to FIGS. 1 and 2. Preferably, steps 310 and 320 are programmed as code segments performed in the printer controller 221 or an additional processor.

Referring to FIG. 3, in step 310, a separation time of the transfer roller 163 is set according to the size of paper. For this purpose, in step 311, whether a command to print is given from the PC 210 is monitored. In step 312, when the command to print is given as a monitoring result of step 311, the paper feeding unit 130, such as a paper feeding roller, is driven.

In step 313, the size of the paper stacked in a tray of the paper feeding cassette 110 is calculated using front and rear ends of the paper sensed by the paper feeding sensor 131. In general, the size of the paper is determined by the length in a paper transfer direction, but the length cannot be directly measured. Thus, the paper feeding sensor 131 is placed at a location adjacent to the paper feeding unit 130, i.e., the paper feeding roller, on a transfer path of the paper. When the front end of the paper is detected by the paper feeding sensor 131, a timer starts operating, and when the rear end of the paper is detected by the paper feeding sensor 131, the timer stops operating. In this way, the length in the paper transfer direction (i.e., the length of the paper in a vertical scanning direction) is determined by a detection time when the front and rear ends of the paper are detected by the paper feeding sensor 131. After the length in the paper transfer direction is determined, the width (i.e., the length of the paper in a horizontal scanning direction) may be determined based on the standard size of the paper.

In step 314, the size of a driver paper is compared with the size of the paper stacked in the tray determined in step 313. The size of the driver paper, i.e., the size of an image formed on the photosensitive drum 151 is provided in advance from the PC 210.

As a comparison result of step 314, when the size of the driver paper, i.e., the size of the image formed on the photosensitive drum 151 is the same as or smaller than the size of the paper stacked in the tray, in step 315, the separation time of the transfer roller 163 is set to a first predetermined time T1. The first predetermined time T1 is set to a time period from a time when the rear end of the paper is detected by the paper feeding sensor 131 to a time when the rear end of the paper is detected by the transfer roller 163. The time period from the time when the rear end of the paper is detected by the paper feeding sensor 131 to the time when the rear end of the paper is detected by the transfer roller 163 is preferably obtained in advance according to a printing speed and stored in a lookup table format.

Meanwhile, as a comparison result of step 314, when the size of the driver paper, (the size of the image formed on the photosensitive drum 151) is larger than the size of the paper stacked in the tray, in step 316, the separation time of the transfer roller 163 is set to a second predetermined time T2. This case corresponds to a case where the size of the image formed on the photosensitive drum 151 in the vertical scanning direction is larger than the size of the paper in the vertical scanning direction determined in step 313. The second predetermined time T2 may be generally set to ‘0’ or a predetermined value smaller than a time period from a time when the rear end of the paper determined in step 313 is detected by the paper feeding sensor 131 to a time when the rear end of the paper is detected by the transfer roller 163. When it is determined that the size of the driver paper is larger than the size of the paper stacked in the tray, the second predetermined time T2 is set to ‘0’ so that an immediate separation between the transfer belt 162 and the transfer roller 163 is achieved.

In step 315 or 316, preferably, a time for completing the separation time setting of the transfer roller 163 is within a time when transfer of the color toner image on the transfer belt 162 is completed.

In step 317, when the color toner image is completely transferred to the transfer belt 162 after the paper feeding roller 130 is driven in step 312, the transfer roller 163 contacts the transfer belt 162 at a predetermined pressure, so as to transfer the toner image of the transfer belt 162 on the paper P, such that a transfer operation is performed.

Meanwhile, in step 320, when the time when the rear end of the paper is detected by the paper feeding sensor 131 reaches the separation time of the transfer roller 163 set in step 315 or 316, the transfer roller 163 is separated from the transfer belt 162.

In step 321, whether the separation time (T1 or T2) of the transfer roller 163 set in step 315 or 316 corresponds to ‘0’ is determined. As a determination result in step 321, when the separation time of the transfer roller 163 corresponds to ‘0’, in step 322, the transfer roller 163 is separated from the transfer belt 162 by controlling a solenoid (not shown) inside the transfer roller 163.

Meanwhile, in step 321, if the separation time of the transfer roller 163 does not correspond to ‘0’, in step 323, 1 is subtracted from a current value of the separation time (T1 or T2) of the transfer roller 163. Step 323 is performed when the first predetermined time T1 or the second predetermined time T2 (not ‘0’) is set to the separation time of the transfer roller 163. In other words, the transfer belt 162 and the transfer roller 163 are maintained in a contact state, and the transfer operation is performed until it reaches the separation time of the transfer roller 163.

After step 322, the paper is normally exhausted through the fusing unit 170 and the paper exhausting unit 180, and the printing operation is terminated.

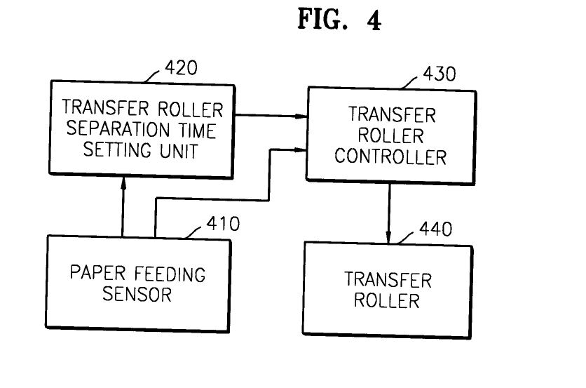

FIG. 4 is a block diagram illustrating a structure of an apparatus for preventing a transfer roller from being contaminated, according to an embodiment of the present invention. The apparatus for preventing a transfer roller from being contaminated includes a transfer roller separation time setting unit 420 and a transfer roller controller 430.

Referring to FIG. 4, the transfer roller separation time setting unit 420 sets a separation time of a transfer roller 440 from a transfer belt (162 of FIG. 1) to a first time period T1 or a second time period T2 according to a comparison between the size of paper picked-up from a stacking unit (110 of FIG. 1) determined using a time when front and rear ends of the paper are detected by the paper feeding sensor 410, and the size of paper set in a printer driver (not shown) calculated based on the size of an image on a photosensitive drum (150 of FIG. 1).

The transfer roller 440 contacts the transfer belt 162 until a time when the rear end of the paper is detected by the paper feeding sensor 410 reaches a transfer roller separation time T1 or T2. During this time, the transfer roller controller 430 performs a transfer operation. When the transfer roller separation time has elapsed, the transfer roller controller 430 separates the transfer roller 440 from the transfer belt 162.

The present invention may be implemented as a computer readable code on a computer readable medium. The computer readable medium includes all types of recording devices on which data that can be read by a computer system are stored, such as ROMs, RAMs, CD-ROMs, magnetic tapes, floppy discs, optical data storage units, and carrier waves (for example, transmission via the Internet). Also, the computer readable medium can be distributed over a network-connected computer system and can be stored and executed as computer readable codes. Functional programs, codes, and code segments for implementing the present invention may be easily inferred by programmers in the field of technology to which the present invention belongs.

As described above, according to the present invention, when the size of paper set in a printer driver in an image forming system (the size of an image formed on a photosensitive drum) is larger than the size of paper supplied from a paper feeding cassette, a transfer roller contacts a transfer belt and simultaneously is immediately separated from the transfer belt, such that the transfer roller can be prevented from being contaminated by toner.

While this invention has been particularly shown and described with reference to a preferred embodiment thereof, it will be understood by those skilled in the art that various changes in form and details may be made therein without departing from the spirit and scope of the invention as defined by the appended claims and equivalents thereof.

1. A method for preventing contamination of a transfer roller in an image forming system, the method comprising:
(a) setting a separation time of the transfer roller from a transfer belt according to the size of paper picked-up from a paper feeding cassette and the size of paper set in a printer driver; and
(b) separating the transfer roller from the transfer belt when the separation time of the transfer roller set in (a) has elapsed.

2. The method of claim 1, wherein (a) comprises:
(a1) comparing the size of the picked-up paper with the size of the set paper;
(a2) if the size of the picked-up paper is the same as or larger than the size of the set paper, setting the separation time to a first predetermined time; and
(a3) if the size of the picked-up paper is smaller than the size of the set paper, setting the separation time to a second predetermined time.

3. The method of claim 2, wherein (a1) is performed with respect to a vertical scanning direction of the picked-up paper and the set paper.

4. The method of claim 2, wherein the first predetermined time is a time period from a time when a rear end of paper is detected by a paper feeding sensor to a time when the rear end of paper is detected by the transfer roller.

5. The method of claim 2, wherein the second predetermined time is a predetermined value smaller than a time period from a time when a rear end of paper is detected by the paper feeding sensor to a time when the rear end of paper is detected by the transfer roller.

6. The method of claim 2, wherein the second predetermined time is ‘0’.

7. The method of claim 1, wherein (b) comprises:
(b1) the transfer belt contacting the transfer roller and performing a transfer operation from the time when the rear end of paper is detected by the paper feeding sensor to the separation time of the transfer roller set in (a); and
(b2) separating the transfer roller from the transfer belt when the separation time of the transfer roller has elapsed.

8. The method of claim 7, wherein if the size of the picked-up paper is the same as or larger than the size of the set paper, the separation time of the transfer roller is a time period from a time when the rear end of paper is detected by the paper feeding sensor to a time when the rear end of the paper is detected by the transfer roller.

9. The method of claim 7, wherein if the size of the picked-up paper is smaller than the size of the set paper, the separation time of the transfer roller is a predetermined value smaller than a time period from a time when the rear end of paper is detected by the paper feeding sensor to a time when the rear end of the paper is detected by the transfer roller.

10. The method of claim 7, wherein if the size of the picked-up paper is smaller than the size of the set paper, the separation time of the transfer roller is ‘0’.

11. A computer readable medium of instructions adapted to control an image forming system to prevent contamination of a transfer roller comprising:
a first set of instructions adapted to control the system to set a separation time of the transfer roller from a transfer belt according to the size of paper picked-up from a paper feeding cassette and the size of paper set in a printer driver; and
a second set of instructions adapted to control the system to separate the transfer roller from the transfer belt when the separation time of the transfer roller has elapsed.

12. The computer readable medium of instructions of claim 11, further comprising:
a third set of instructions adapted to control the system to compare the size of the picked-up paper with the size of the set paper;
to set the separation time to a first time period if the size of the picked-up paper is the same as or larger than the size of the set paper; and
to set the separation time to a second time period if the size of the picked-up paper is smaller than the size of the set paper.

13. The computer readable medium of instructions of claim 11, further comprising:
a third set of instructions adapted to control the transfer roller to contact the transfer belt and perform a transfer operation from the time when the rear end of paper is detected by the paper feeding sensor to the set separation time of the transfer roller; and
a fourth set of instructions adapted to control the transfer roller to separate the transfer roller from the transfer belt when the separation time of the transfer roller has elapsed.

14. An apparatus for preventing contamination of a transfer roller in an image forming system, the apparatus comprising:
a transfer roller separation time setting unit, which sets a separation time of a transfer roller from a transfer belt to a first or second time period according to a comparison result in which the size of paper picked-up from a stacking unit is compared with the size of paper set in a printer driver; and
a transfer roller controller, which makes the transfer belt contact the transfer roller to perform a transfer operation from a time when a rear end of paper is detected by a paper feeding sensor to the set separation time of the transfer roller, and which separates the transfer roller from the transfer belt when the separation time of the transfer roller has elapsed.

15. The apparatus of claim 14, wherein comparison of the size of the picked-up paper with the size of the set paper is performed with respect to vertical scanning directions of the picked-up paper and the set paper.

16. The apparatus of claim 14, wherein if the size of the picked-up paper is the same as or larger than the size of the set paper, the first time period is a time period from a time when a rear end of paper is detected by a paper feeding sensor to a time when the rear end of paper is detected by the transfer roller.

17. The apparatus of claim 14, wherein if the size of the picked-up paper is smaller than the size of the set paper, the second time period is within a time period from a time when a rear end of paper is detected by the paper feeding sensor to a time when the rear end of paper is detected by the transfer roller.

18. The apparatus of claim 14, wherein if the size of the picked-up paper is smaller than the size of the set paper, the second time period is ‘0’.

19. An image forming system comprising a controller adapted to perform the following operations:
setting a separation time of a transfer roller from a transfer belt to a first or second time period according to a comparison result in which the size of paper picked-up from a paper feeding cassette is compared with the size of paper set in a printer driver;
controlling the transfer belt such that the transfer belt contacts the transfer roller to perform a transfer operation from a time when a rear end of paper is detected by a paper feeding sensor to the set separation time of the transfer roller; and
separating the transfer roller from the transfer belt when the separation time of the transfer roller has elapsed.
